(19) United States
(12) Patent Application Publication
(10) Pub. No.: US 2020/0149345 A1
(43) Pub. Date: May 14, 2020

(54) Insert Unit, Insulated Glass Unit Comprising Said Insert Unit and Method for Manufacturing the Insulated Glass Unit

(71) Applicant: ES Blinds B.V., Eindhoven (NL)

(72) Inventor: Roland Rottler, Oberasbach (DE)

(21) Appl. No.: 16/680,987

(22) Filed: Nov. 12, 2019

(30) Foreign Application Priority Data
Nov. 9, 2018 (NL) 2021967

(51) Int. Cl. E06B 9/264; E06B 3/67; E06B 3/663; E06B 3/66; E06B 3/673

(52) U.S. Cl. CPC E06B 9/264; E06B 3/6722; E06B 3/66304; E06B 9/30; E06B 3/67326; E06B 3/66366; E06B 2009/2643; E06B 3/6612

(57) ABSTRACT

Insert unit (135) arranged for being provided in a sealed chamber (113) of an insulated glass unit (101), said insert unit (135) comprising two glass panes (119, 121) and a spacer (123) spacing apart said two glass panes (119, 121), wherein said two glass panes (119, 121) and said spacer (123) define a receiving space (127), said insert unit (135) further comprising a sun protection system (110) received in said receiving space (127), wherein said spacer (123) is provided with at least one convection opening (131, 133) for allowing a fluid to flow via said spacer (123) in and out of said receiving space (127). Insulated glass unit (101) comprising said insert unit (135) and method for manufacturing the insulated glass unit (101).

The present disclosure relates according to a first aspect to an insert unit arranged for being provided in a sealed chamber of an insulated glass unit.

According to a second aspect the present disclosure relates to an insulated glass unit comprising an insert unit according to the first aspect of the present disclosure.

According to a third aspect the present disclosure relates to a method for manufacturing the insulated glass unit according to the second aspect.

Insulating glass, also known as double glazing, double pane or insulated glass unit, comprises at least two glass panes separated by a gas, such as air, argon or krypton, filled space to reduce heat transfer across a part of a building envelope. A known insulated glass unit comprises a sun protection system in the form of movable blinds provided in said vacuum or gas filled space. A drawback of these known insulated glass units is that the sun protection system may be improved as regards the operational reliability.

An objective of the present disclosure is to provide a solution for overcoming the drawback of the known insulating glass unit while maintaining a relative low heat transfer between outer glass panes of the insulating glass unit.

The objective is achieved by the insert unit according to the present disclosure. The insert unit according to the first aspect is arranged for being provided in a sealed chamber of an insulated glass unit. The insert unit comprises two glass panes and a spacer spacing apart said two glass panes, wherein said two glass panes and said spacer define a receiving space. The insert unit further comprises a sun protection system received in said receiving space, wherein said spacer is provided with at least one convection opening for allowing a fluid to flow via said spacer in and out of said receiving space.

The present disclosure at least partly relies on the insight that environmental conditions such as pressure and temperature may result in a deformation of the outer glass panes of an insulated glass unit. It is found that such a deformation of the outer glass panes may result in a relative low operational reliability for instance due to a limitation of the available space for moving the blinds into a position. In particular for known insulated glass units wherein the blinds are directly applied to one of the outer glass panes, a deformation of the outer glass pane may lead to a disturbed or reduced movability of the blinds.

By providing an insert unit according to the first aspect the influence of a deformation of the outer glass panes of the insulated glass unit on the sun protection system is avoided, or at least significantly reduced. A change in environmental conditions such as a change in pressure or temperature of the ambient air has no, or only a limited, effect on the glass panes of the insert unit by providing the at least one convection opening in said spacer of said insert unit. As a result of the at least one convection opening in the spacer the pressure in said sealed chamber and said receiving space are equal thereby avoiding a deformation of the glass panes of the insert unit. For this reason the operational reliability of the sun protection system is improved while maintaining a relative low heat transfer between outer glass panes of the insulating glass unit.

An additional advantage of the insert unit according to the first aspect of the present disclosure is that the insert unit may be provided in predefined dimensions. An insert unit having predetermined dimensions is beneficial for decoupling the requirements as regards the dimensions of the sun protection system from the dimensions of the insulating glass unit. In other words, an insert unit having a predetermined dimension may be provided in any insulating glass unit having a sealed chamber larger than outer dimensions of said insert unit. This allows for realising a relative cost effective insert unit and insulating glass unit having a relative high operational reliability of the sun protection system while maintaining a relative low heat transfer between outer glass panes of the insulating glass unit.

Preferably, said insert unit comprises a holding arrangement, wherein said two glass panes and said spacer are held together by said holding arrangement.

It is advantageous if said sun protection system comprises spaced apart strips.

In one embodiment of the insert unit, it is beneficial if said spaced apart strips are attached to one of said two glass panes.

In an embodiment of the insert unit according to the first aspect of the present disclosure, said spacer comprises a plurality of convection openings provided at opposite sides of said insert unit for allowing said fluid to flow in and out of said receiving space and across said receiving space. This is beneficial for communicatively coupling the receiving space and the sealed chamber for fluid flow and thereby avoiding, or at least significantly reducing deformation of the glass panes of the insert unit and thereby realising a relative high operational reliability of the sun protection system while maintaining a relative low heat transfer between outer glass panes of the insulating glass unit.

According to the second aspect, the present disclosure relates to an insulated glass unit comprising two outer glass panes and an outer spacer spacing apart said two outer glass panes, wherein said two outer glass panes and said outer spacer define said sealed chamber, wherein an insert unit according to the first aspect is received in said sealed chamber. Embodiments of the insulated glass unit correspond to embodiments of the insert unit according to the first aspect of the present disclosure. The advantages of the insulated glass unit correspond to advantages of the insert unit according to first aspect of the present disclosure presented previously.

In this regard it is beneficial if said receiving space is communicatively coupled for fluid flow, by said at least one convection opening, with said sealed chamber. This is beneficial for communicatively coupling the receiving space and the sealed chamber for fluid flow and thereby avoiding, or at least significantly reducing, deformation of the glass panes of the insert unit and thereby realising a relative high operational reliability of the sun protection system while maintaining a relative low heat transfer between outer glass panes of the insulating glass unit.

It is beneficial if said insulated glass unit comprises a cover frame, wherein said cover frame is arranged such that said cover frame, one glass pane of said two glass panes and one outer glass pane of said two outer glass panes define a further sealed chamber provided in said sealed chamber for avoiding fluid flow from said receiving space along said one outer glass pane of said two outer glass panes. By providing the further sealed chamber a flow of fluid inside said chamber along said outer glass pane is prevented thereby realising a relative low heat transfer across the insulated glass unit.

In an advantageous embodiment of the insulated glass unit according to the second aspect said insulated glass unit comprises a fixation arrangement for fixating said insert unit relative to said two outer glass panes and said outer spacer.

In this regard it is beneficial if said fixation arrangement comprises said cover frame for fixating said insert unit relative to said two outer glass panes and said outer spacer.

Preferably, said insulated glass unit comprises an outer holding arrangement, wherein said two outer glass panes and said outer spacer are held together by said outer holding arrangement.

According to the third aspect, the present disclosure relates to a method for manufacturing an insulated glass unit according to the second aspect of the present disclosure, said method comprising the steps of:
receiving said insert unit between said two outer glass panes and said outer spacer; and connecting said two outer glass panes with said outer spacer for realising said sealed chamber.

The advantages of the method according to the third aspect correspond to advantages of the insert unit according to first aspect of the present disclosure and the insulated glass unit according to the second aspect of the present disclosure presented previously.

It is beneficial if said method further comprises the step of:

fixating said insert unit, by said fixation arrangement, relative to said two outer glass panes and said outer spacer.

In a very practical embodiment of the method according to the third aspect, said method further comprises the steps of:

providing a plurality of fixation arrangements having different predetermined dimensions;

selecting, from said plurality of fixation arrangements, a fixation arrangement for said fixating of said insert unit relative to said two outer glass panes and said outer spacer.

The availability of a plurality of fixation arrangements having predetermined dimensions is beneficial for using an insert unit having predetermined dimensions and thereby decoupling the requirements as regards the dimensions of the sun protection system from the dimensions of the insulating glass unit. In other words, an insert unit having a predetermined dimension may be provided in any insulating glass unit having a sealed chamber larger than said outer dimensions of the insert unit. This allows for realising a relative cost effective insert unit and insulating glass unit having a relative high operational reliability of the sun protection system while maintaining a relative low heat transfer between outer glass panes of the insulating glass unit.

The present invention will now be explained by means of a description of a prior art insulated glass unit, an insert unit and an insulated glass unit according to the present disclosure, in which reference is made to the following schematic figures, in which:

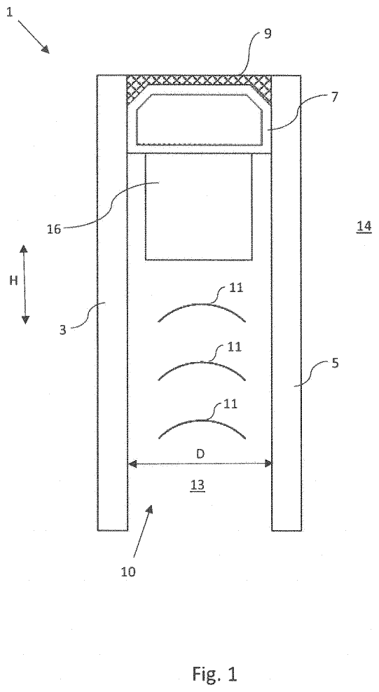

FIG. 1: a detail of a prior art insulated glass unit in a first state is shown;

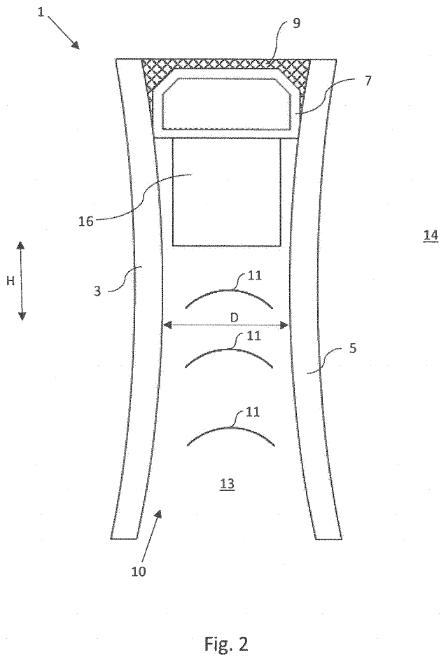

FIG. 2: the detail of the insulated glass unit from FIG. 1 in a second state is shown;

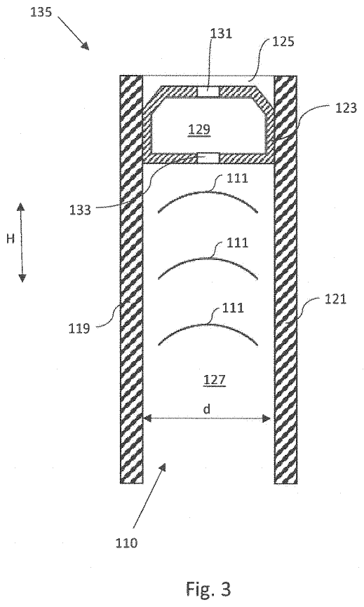

FIG. 3: a detail of an insert unit according to the first aspect of the present disclosure is shown;

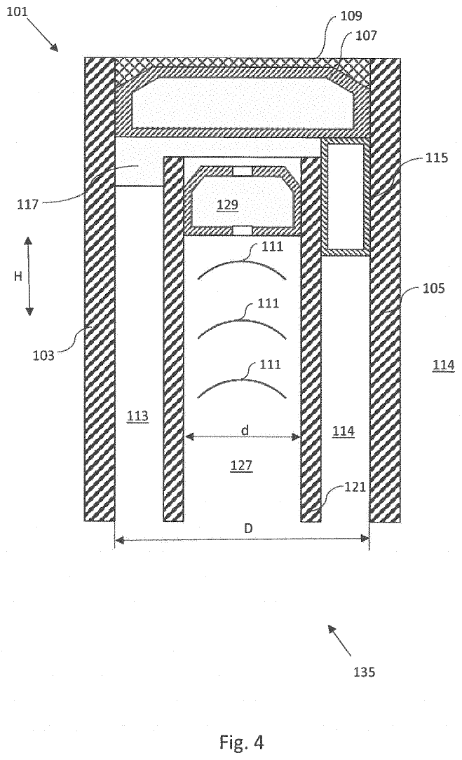

FIG. 4: a detail of an insulated glass unit according to the second aspect of the present disclosure is shown.

The known insulated glass unit 1 comprises two glass panes 3 and 5 which are spaced apart at a distance D by an outer spacer 7. The spacer 7 may be formed of extruded profiles that are connected for forming a rectangular frame. The two glass panes 3, 5 and the spacer 7 are glued together by applying a layer of glue 9 on the outside of the spacer 7 for sealing a chamber 13 from the ambient air 14. Inside the chamber 13 a sun protection system 10 is attached to the spacer 7. The sun protection system 10 comprises parallel strips 11, wherein the position of the strips 11 may be controlled by a control organ (not shown). The control organ is coupled to the strips 11 via a movement arrangement 16 provided in said chamber 13 and directly coupled to said strips 11. The strips 11 may be moved towards each other in direction H and/or may each be rotated about a virtual axis extending in a direction corresponding to a longitudinal direction of the strips 11.

FIG. 1 shows a state of the insulated glass unit 1 wherein the glass panes 3 and 5 are free from deformation due to for instance pressure and/or temperature from the ambient air 14. This may for instance occur when the pressure inside the sealed chamber 13 is equal to the pressure of the ambient air 14. The state of the insulated glass unit 1 shown in FIG. 2 may relate to a situation wherein the pressure of the ambient air 14 is larger than a pressure inside said chamber 13 as a result of which the glass panes 3 and 5 may be pressed towards each other and thereby locally reducing the spacing D between the glass panes 3 and 5. Such a reduction of the spacing D between the glass panes 3 and 5 may lead to a reduction of the operational reliability of the sun protection system 10. In particular when the spacing D between the glass panes 3 and 5 reduces to such an extent that the strips 11 are in contact with at least one of the glass panes 3, 5 a position of the strips may be changed or movement of the strips 11 may be blocked.

The insert unit 135 comprises two glass panes 119, 121 and a spacer 123 spacing apart said two glass panes 119, 121 at a distance d. The two glass panes 119, 121 and said spacer 123 define a receiving space 127. The spacer 123 is formed of extruded profiles that are connected for forming a rectangular frame. The two glass panes 119, 121 and the spacer 123 are held together by a holding arrangement. The holding arrangement comprises a layer of glue 125 which is applied on the outside of the spacer 123. The spacer 123 is provided with a first through hole 133 and a second through hole 131 in opposite walls of said extruded profile such that said first and second through hole 131 and 133 allow a fluid such as air to move in and out of said receiving space 127. At a side of said insert unit 135 opposite the detail of the insert unit 135 shown in FIG. 3 the spacer 123 is provided with further through holes (not shown) for allowing said fluid to flow across said receiving space 127. It is noted that the layer of glue 125 is applied such that the second through hole is connected for fluid flow with the exterior of the insert unit 135. Inside the receiving space 127 a sun protection system 110 is provided. The sun protection system 110 may be attached to the spacer 123 in a manner similar as shown in FIGS. 1 and 2. The sun protection system 110 comprises parallel strips 111, wherein the position of the strips 111 may be controlled by a control organ (not shown). The control organ may be coupled to the strips 111 via a movement arrangement (not shown) provided in said receiving space 127 and directly coupled to said strips 111. Alternatively it is conceivable that the movement arrangement is provided outside the receiving space. The strips 11 may be moved towards each other in direction H and/or may each be rotated about a virtual axis extending in a direction corresponding to a longitudinal direction of the strips 11.

The insulated glass unit 101 comprises two outer glass panes 103, 105 and an outer spacer 107 spacing apart said two outer glass panes 103, 105 at a distance D. The two outer glass panes 103, 105 and the outer spacer 107 define a chamber 113. The outer spacer 107 may be formed of extruded profiles that are connected for forming a rectangular frame. The two outer glass panes 103, 105 and the outer spacer 107 are held together by an outer holding arrangement. The outer holding arrangement comprises a layer of glue 109 on the outside of the outer spacer 107 for sealing the chamber 113 from the ambient air 114. Inside the chamber 113 an insert unit 135 is provided. The insert unit 135 is fixated in said chamber 113 by a fixation arrangement comprising setting blocks 117. The setting blocks 117 may be provided at a plurality of positions along a perimeter of the insert unit 135 and clamp the insert unit 135 in a fixed position relative to the outer frame 107. The insulated glass unit 101 further comprises a cover frame 105. The cover frame may be formed of extruded profiles that are connected for forming a further rectangular frame. The cover frame 105 is positioned such in the chamber 113 that the cover frame 115, outer glass pane 105 and glass pane 121 define a further sealed chamber 114. By providing the further sealed chamber 114 a flow of fluid inside said chamber 113 originating from said receiving space 127 along said outer glass pane 121 is prevented thereby realising a relative low heat transfer across the insulated glass unit 101. Moreover, said cover frame 115 urges against said insert unit 135 for fixating said insert unit 135 relative to said outer frame 107. The distance D between the two outer glass panes 103, 105 is larger than distanced between the two glass panes 119, 121, a combined thickness of the two glass panes and a safety margin for avoiding contact of the two outer glass panes 103, 105 with the two glass panes 119, 121 due to deformation of the two outer glass panes 103, 105.

The insulating glass unit 101 may be manufactured by providing a first outer glass pane 105, preferable in a horizontal position, and placing the outer frame 107 onto said first outer glass pane 105. Subsequently, the cover frame 115 is place onto said first outer glass pane 105 inside said outer frame 107. After the cover frame 115 is positioned, the insert unit 135 is lowered onto said cover frame 115 and fixated relative to said outer frame 105 by pressing setting blocks 117 between the insert unit 135 and the outer frame 107. The setting blocks 117 may be chosen from a plurality of setting blocks having predetermined dimensions for realising a fixation of the insert unit 135 to the frame 107. In an embodiment of the insulated glass unit the setting blocks may be chosen such that a distance between the insert unit and the outer frame may vary along the perimeter of the insert unit. After the step of fixating the insert unit 135 to the outer frame 107, a second outer glass pane 103 is placed on the outer frame 107 and the outer frame 107, the first glass pane 105 and the second glass pane 103 are glued together by said layer of glue 109.

1. An insert unit (135) arranged for being provided in a sealed chamber (113) of an insulated glass unit (101), said insert unit (135) comprising:
two glass panes (119, 121) and a spacer (123) spacing apart said two glass panes (119, 121), wherein said two glass panes (119, 121) and said spacer (123) define a receiving space (127), said insert unit (135) further comprising a sun protection system (110) received in said receiving space (127), wherein said spacer (123) is provided with at least one convection opening (131, 133) for allowing a fluid to flow via said spacer (123) in and out of said receiving space (127).

2. The insert unit (135) according to claim 1, wherein said insert unit (135) comprises a holding arrangement (125), wherein said two glass panes (119, 121) and said spacer (123) are held together by said holding arrangement (125).

3. The insert unit (135) according to claim 1, wherein said sun protection system (110) comprises spaced apart strips (111).

4. The insert unit (135) according to claim 3, wherein said spaced apart strips are attached to one of said two glass panes.

5. The insert unit (135) according to claim 1, wherein said spacer (123) comprises a plurality of convection openings (131, 133) provided at opposite sides of said insert unit (135) for allowing said fluid to flow in and out of said receiving space and across said receiving space (127).

6. An insulated glass unit (101) comprising:
an insert unit, the insert unit comprises:
two glass panes (119, 121) and a spacer (123) spacing apart said two glass panes (119, 121), wherein said two glass panes (119, 121) and said spacer (123) define a receiving space (127), said insert unit (135) further comprising a sun protection system (110) received in said receiving space (127), wherein said spacer (123) is provided with at least one convection opening (131, 133) for allowing a fluid to flow via said spacer (123) in and out of said receiving space (127); and
two outer glass panes (103, 105) and an outer spacer (107) spacing apart said two outer glass panes (103, 105), wherein said two outer glass panes (103, 105) and said outer spacer (107) define a sealed chamber (113), wherein the insert unit (135) is received in said sealed chamber (113).

7. The insulated glass unit (101) according to claim 6, wherein said receiving space (127) is communicatively coupled for fluid flow, by said at least one convection opening (131, 133), with said sealed chamber (113).

8. The insulated glass unit (101) according to claim 6, wherein said insulated glass unit (101) comprises a cover frame (115), wherein said cover frame (115) is arranged such that said cover frame (115), one glass pane of said two glass panes (119, 121) and one outer glass pane of said two outer glass panes (103, 105) define a further sealed chamber (114) provided in said sealed chamber (113) for avoiding fluid flow from said receiving space (127) along said one outer glass pane of said two outer glass panes (103, 105).

9. The insulated glass unit (101) according to claim 6, wherein said insulated glass unit (101) comprises a fixation arrangement (117) for fixating said insert unit (135) relative to said two outer glass panes (103, 105) and said outer spacer (107).

10. The insulated glass unit (101) according to claim 9, wherein said fixation arrangement comprises said cover frame (115) for fixating said insert unit (135) relative to said two outer glass panes (103, 105) and said outer spacer (107).

11. The insulated according to claim 6, wherein said insulated glass unit (101) comprises an outer holding arrangement (109), wherein said two outer glass panes (103, 105) and said outer spacer (107) are held together by said outer holding arrangement (109).

12. A method for manufacturing an insulated glass unit (101), the insulated glass unit comprising an insert unit, the insert unit comprises two glass panes (119, 121) and a spacer (123) spacing apart said two glass panes (119, 121), wherein said two glass panes (119, 121) and said spacer (123) define a receiving space (127), said insert unit (135) further comprising a sun protection system (110) received in said receiving space (127), wherein said spacer (123) is provided with at least one convection opening (131, 133) for allowing a fluid to flow via said spacer (123) in and out of said receiving space (127) and two outer glass panes (103, 105) and an outer spacer (107) spacing apart said two outer glass panes (103, 105), wherein said two outer glass panes (103, 105) and said outer spacer (107) define a sealed chamber (113), wherein the insert unit (135) is received in said sealed chamber (113), said method comprising the steps of:
receiving said insert unit (135) between said two outer glass panes (103, 105) and said outer spacer (107); and
connecting said two outer glass panes (103, 105) with said outer spacer (107) for realising said sealed chamber (113).

13. The method according to claim 12 for manufacturing an insulated glass unit (101), wherein said method further comprises the step of:
fixating said insert unit (135), by said fixation arrangement (117), relative to said two outer glass panes (103, 105) and said outer spacer (107).

14. The method according to claim 13, wherein said method further comprises the steps of:
providing a plurality of fixation arrangements having different predetermined dimensions;
selecting, from said plurality of fixation arrangements, a fixation arrangement for said fixating of said insert unit (135) relative to said two outer glass panes (103, 105) and said outer spacer (107).

15. The insulated glass unit (101) according to claim 6, wherein said insert unit (135) comprises a holding arrangement (125), wherein said two glass panes (119, 121) and said spacer (123) are held together by said holding arrangement (125).

16. The insulated glass unit (101) according to claim 6, wherein said sun protection system (110) comprises spaced apart strips (111).

17. The insulated glass unit (101) according to claim 6, wherein said spaced apart strips are attached to one of said two glass panes.

18. The insulated glass unit (101) according to claim 6, wherein said spacer (123) comprises a plurality of convection openings (131, 133) provided at opposite sides of said insert unit (135) for allowing said fluid to flow in and out of said receiving space and across said receiving space (127).
